(19) United States
(12) Patent Application Publication
(10) Pub. No.: US 2007/0113437 A1
(43) Pub. Date: May 24, 2007

(54) Device for displaying product information

(76) Inventor: Erica Leighann Biser, Pinecrest, FL (US)

Correspondence Address: NATH & ASSOCIATES PLLC, 6th Fl., 1030 15th St., N.W., Washington, DC, 20005-1503, US

(21) Appl. No.: 11/282,590

(22) Filed: Nov. 21, 2005

(51) Int. Cl. G09F 7/00

(52) U.S. Cl. 40/492

(57) ABSTRACT

A device displays information about a product. The device includes an inner surface having printed information about the product and an outer surface that folds over the inner surface to obscure and protect the inner surface. The outer surface has printed information about the product, and also has an attachment mechanism. The device also includes a notch used by the operator to unfold the device to reveal the inner surface and obscure the outer surface, and to fold the device to obscure the inner surface and reveal the outer surface.

### FIELD OF THE INVENTION

This invention is in the field of information displays and, more particularly, in the field of two-sided displays for images and information related to flooring samples.

### BACKGROUND OF THE INVENTION

Presently, it is difficult to convey information to a potential buyer of flooring. Frequently, descriptive information and photographs about flooring samples are presented on a paper display, often in a binder or a catalog. This is problematic for many reasons. The displays can become damaged and dirty from use. The samples and the displays can become disordered, confusing the buyer. The display pages may present pictures of the flooring in use; such pictures are difficult to observe simultaneous with the samples. The large amount of information available to the consumer about each flooring type may necessitate a binder or catalog so large that the task of browsing samples becomes inconvenient or uncomfortable. All of these inconvenience the buyer and make the buying experience unpleasant, leading to poor sales.

Presenting descriptive information adjacent to flooring samples also creates problems. Sometimes, information is attached to the back of a sample, requiring the buyer to exert himself in turning over each sample, and making it impossible to view the sample and its information at the same time. Alternately, information is sometimes attached to the front of the sample, which is aesthetically unpleasant and detracts from the desired presentation of the complete sample. Even when information is placed adjacent to the sample, the display has typically been undesirably large, and consequently confusing and inconvenient to compare across samples. Moreover, most informational displays are of a generally poor quality in image. Again, all of these problems detract from the experience of sampling and buying flooring.

The field of flooring sales would benefit greatly from a display for information and images related to flooring samples which can be shown near a sample without obscuring it, and which displays useful descriptions and photographs of the sample in use while protecting those descriptions and photographs from damage. Such an improved display would present sufficient information for comparison shopping, but in an indexed form that a buyer can use while browsing large numbers of samples.

### SUMMARY OF THE INVENTION

The present invention is directed to a device for displaying information about a product. The device includes an inner surface having printed information about the product and an outer surface that folds over the inner surface to obscure and protect the inner surface. The outer surface has printed information about the product, and also has an attachment mechanism. The device also includes a notch used by the operator to unfold the device to reveal the inner surface and obscure the outer surface, and to fold the device to obscure the inner surface and reveal the outer surface.

As used herein, the term “obscure,” when used in describing states of the inner and outer surfaces, is intended to define a condition in which at least portions of the surface are temporarily prevented from being viewed by the operator. This can occur when the device is folded in half, the inner surface therefore being contained within the device. This can also occur when the device is attached to a rigid surface and subsequently unfolded; the side of the device so attached would therefore be in complete contact with the rigid surface and thus obscured. The term “obscure” may mean, but is not limited to meaning, complete obstruction of one or the other surface. A portion of one surface may remain visible even when the remainder of that surface is obscured, as when underneath a notch, seen through a hole, or when otherwise only partially covered.

In one embodiment, there is provided a device for displaying information about flooring. The device is attached near a flooring sample, and includes an inner surface having printed information about flooring including descriptions, dimensions, photographs and vendor contacts; an outer surface having printed information about flooring including descriptions, dimensions, photographs and vendor contacts and further having adhesive strips; and a notch placed at the corner of the device in such a way as to reveal information behind it, said notch used by the operator to unfold the device to reveal the inner surface and obscure the outer surface, and to fold the device to obscure the inner surface and reveal the outer surface.

In another embodiment, the device is attached to a rigid sheet, and one or more of these rigid sheets are assembled into a stand for displaying one or more devices simultaneously.

The present invention is further directed to a method for displaying information about a product. The method involves showing printed information on an inner surface about a product, and obscuring and protecting the inner surface with an outer surface that folds over the inner surface. The method further involves showing printed information on the outer surface, attaching the device to another surface, and alternately obscuring and revealing the inner surface by respectively folding and unfolding the device.

The present invention is further directed to a system for displaying information about a product. The system includes means for showing printed information on an inner surface about a product, and means for obscuring and protecting the inner surface by way of an outer surface that folds over the inner surface. The system further includes means for showing printed information on the outer surface, means for attaching the device to another surface, and means for alternately obscuring and revealing the inner surface by respectively folding and unfolding the device.

These and other aspects, objects, features and advantages of the present invention will be more clearly understood and appreciated from a review of the following detailed description of the embodiments and appended claims, and by reference to the accompanying drawings.

### BRIEF DESCRIPTION OF THE FIGURES

In the detailed description of the invention presented below, reference is made to the accompanying drawings in which:

FIG. 1a is an oblique view of a device according to the present invention, where the device is partially open and the notch is placed on the right side;

FIG. 1b shows an oblique view of a device according to the present invention, where the device is partially open and the notch is placed on the left side

FIG. 2a is a front view of the device of FIG. 1, folded to reveal part of the outer surface and to obscure the inner surface except where revealed by the notch

FIG. 2b is a front view of the device of FIG. 1, unfolded to reveal the entire inner surface and to obscure the entire outer surface.

FIG. 3 is a back view of the device of FIG. 1, showing the attachment mechanism.

FIG. 4 is a device according to the present invention placed next to a flooring sample.

FIG. 5 is the device of FIG. 4, where both the device and a flooring sample are attached to a surface of a rigid sheet, and multiple rigid sheets are assembled into a stand for displaying multiple devices simultaneously.

### DETAILED DESCRIPTION OF THE INVENTION

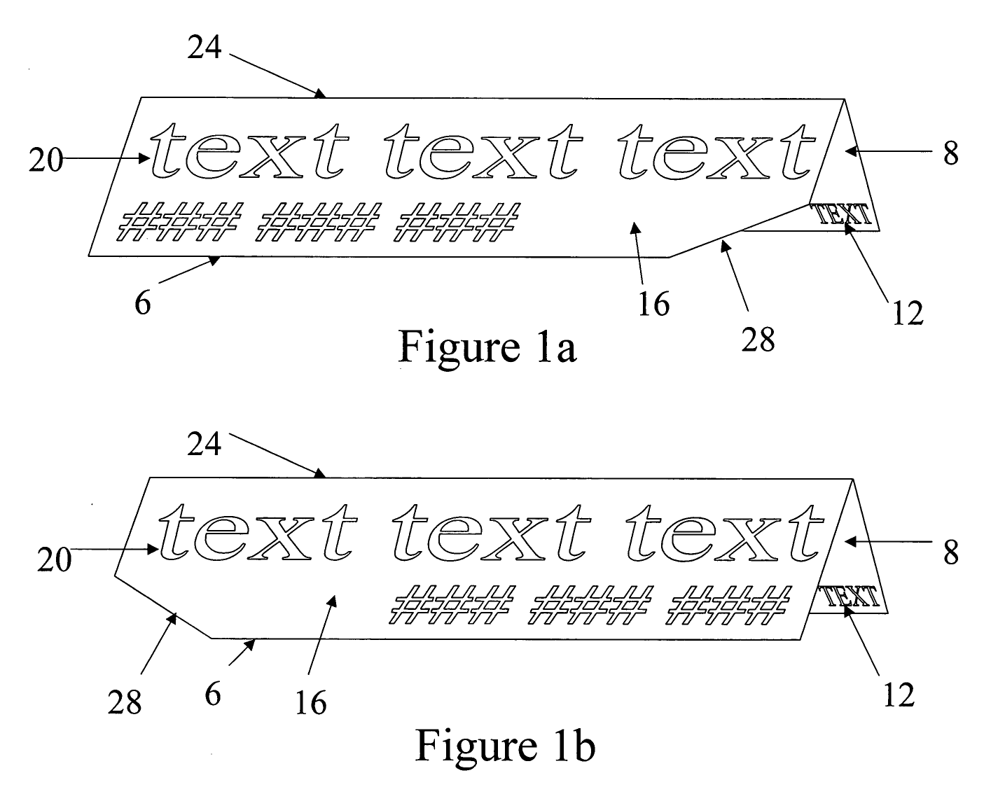

Referring to FIGS. 1a and 1b, the device 6 includes an inner surface 8 with information 12 thereon and an outer surface 16 with information 20 thereon. The device 6 may be made of paper, plastic, metal, paperboard, cardboard, thermoplastic sheet material, photo paper, or any other material suitable for the display of information. The inner surface 8 and the outer surface 16 may be formed of the same material, or may be printed on separate material and joined to form a single device. The inner surface 8 need not be a continuous piece of material, but may be assembled to form a single surface from one or more pieces of material, and may contain one or more holes. Likewise the outer surface 16 need not be a continuous piece or material, but may be assembled to form a single surface from one or more pieces of material, and may contain one or more holes. The device 6 may be made of a rigid or a flexible material, and may be protected from sunlight, weather, and wear by a protective coating such as a laminate or a plastic.

The printed information 12, 20 can refer to a product's description, photograph, variations, uses, vendor, vendor contact information, dimensions, qualities, price, availability, or any other information useful when reviewing product options. This information can consist of text, numbers, measurements, photographs, pictures, diagrams, charts, and any other means of informational conveyance. An especially useful configuration has the information 20 which is on the outer surface 16 consist of an index of qualities of a product, while the information 12 which is on the inner surface 8 consist of a full disclosure of these qualities. This allows a user to quickly browse across products by reading only the outer surfaces 16, and then to explore individual products of his selection in greater depth by reading those inner surfaces 8.

The device 6 is folded along fold 24 to obscure the inner surface 8, except where revealed by the notch 28 in the present embodiment. The fold 24 can be an actual fold in the material of the device 6, or it may be a hinge or hinging mechanism between two distinct pieces of material which together form the device 6. The notch 28 can be formed by the removal of a portion of the material which forms the device, as in the present embodiment. Alternately, the notch 28 can be formed by the protrusion of same material, or by the attachment of a tab, tongue, or similar mechanism. The notch can be placed in the lower right hand corner of the device, as in FIG. 1a, or in the lower left hand corner of the device, as in FIG. 1b, or in any other location that allows an operator to fold and unfold the device by use of the notch.

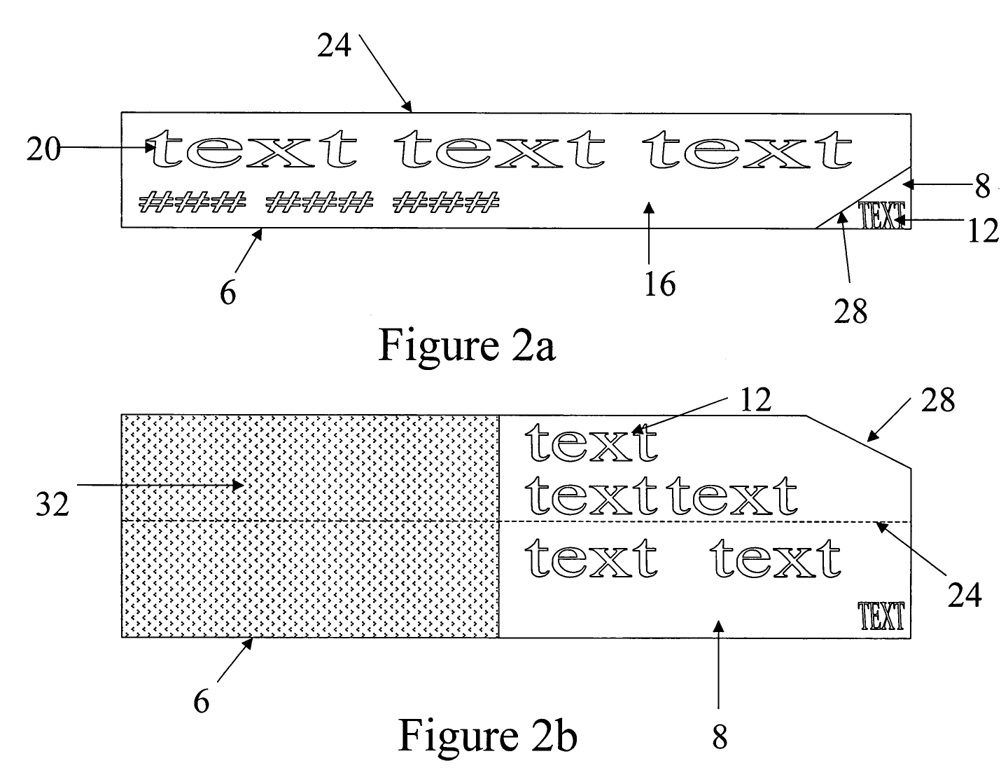

FIG. 2a shows the device of FIG. 1a folded along fold 24 to reveal part of the outer surface 16 and to obscure the inner surface 8. In this embodiment, an especially useful and attractive appearance is achieved wherein a portion of the information 12 on the inner surface 8 is positioned behind the notch 28, so that this information is revealed behind the notch, and remains visible whether the device is folded or unfolded. Only a portion of the outer surface 16 is revealed in this configuration, as the remaining portion of the outer surface forms the unseen back of the device.

FIG. 2b shows the device of FIG. 2a unfolded along fold 24 to reveal the entire inner surface 8 and to obscure the entire outer surface 16. The revealed inner surface 8 contains textual information 12 along with an optional photograph 32. An especially useful embodiment has a photograph 32 of the product being used in an appropriate setting.

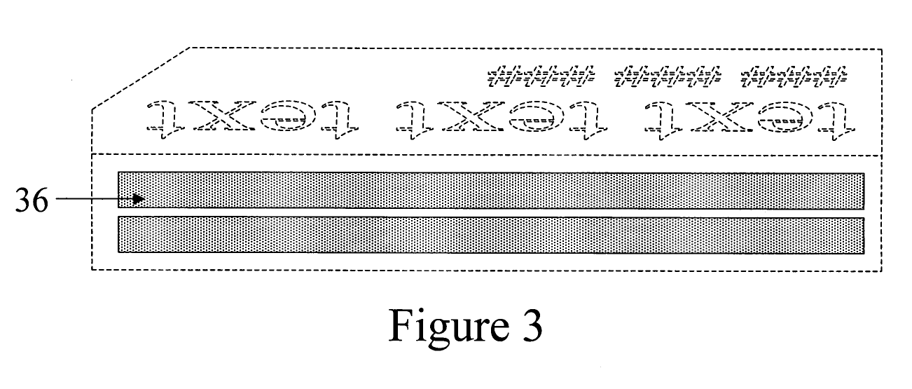

FIG. 3 shows a back view of the device of FIG. 1 in an unfolded state. A portion of the outer surface is covered with an adhesive mechanism 36 which may be used to position the device near the product being advertised. The adhesive mechanism 36 can be anything which aids in the attachment of the device to another surface, including, but not limited to, glue, tape, epoxy, hook, loop, staples, nails, magnets, adhesive strips, and rubber cement. Due to the placement of the adhesive mechanism 36, the device can remain fixed to a surface while being folded and unfolded. The adhesive mechanism 36 thus provides the force which holds the device in place as the operator uses the notch to unfold the device.

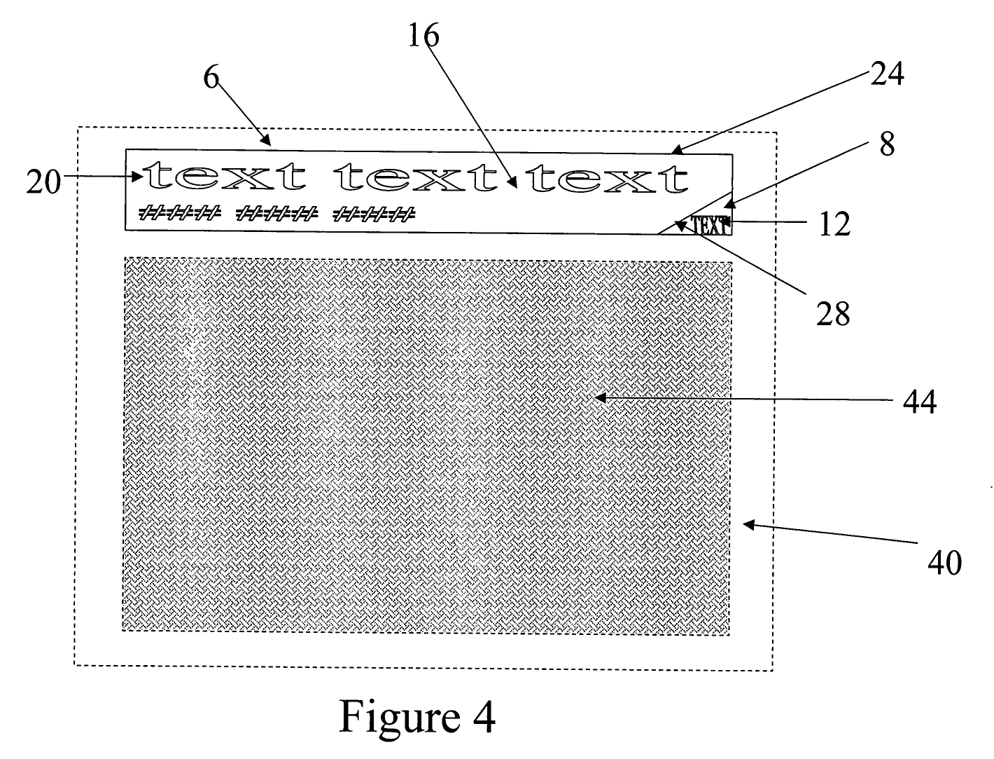

FIG. 4 shows the device 6 attached to a surface 40. The device is placed adjacent to a flooring sample 44. In this position, the user can read the information 20 printed on the outer surface 16, which relates to the flooring demonstrated by sample 44. Then, by unfolding the device 6 along fold 24 by lifting at the notch 28, the user can reveal the information 12 printed on the inner surface 8, which may include photographs of flooring that can be compared to the sample 44 under simultaneous view.

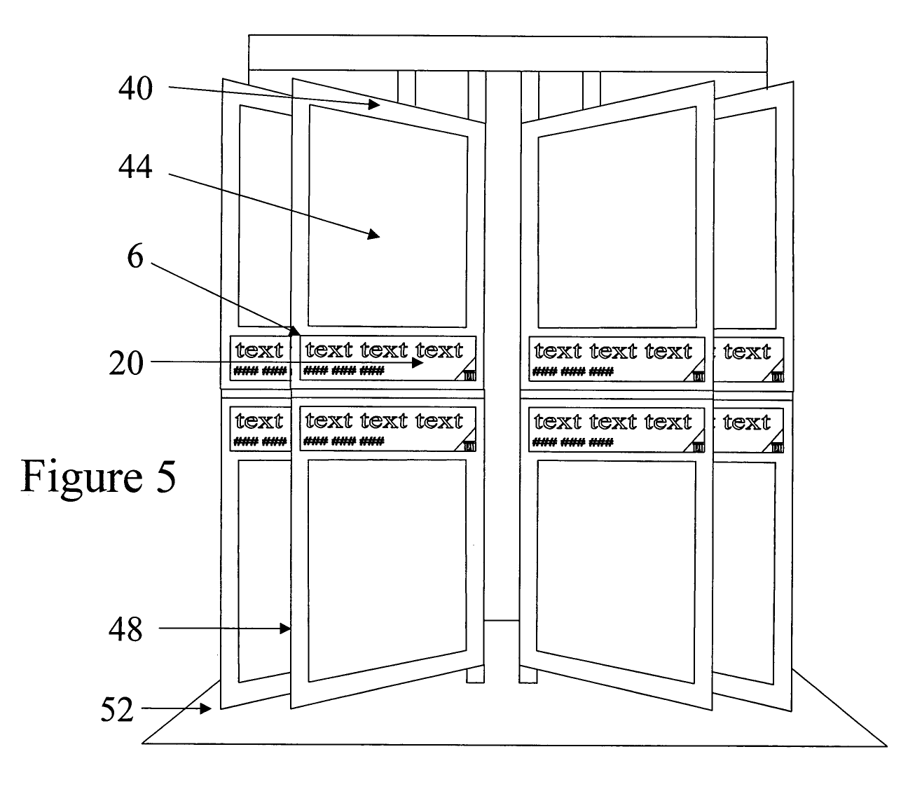

FIG. 5 shows the device 6 and a flooring sample 44 attached to the surface 40 of a rigid sheet 48. Multiple rigid sheets are attached to a stand 52. In this configuration, the user can compare the device 6 and its information 20 to other devices and their information, and can also compare the flooring sample 44 to other flooring samples. The stand can present two, three, four or more devices 6, accompanied by their samples 44 at one time, and may obscure some devices and samples while revealing others. The rigid sheets 48 can be attached to the stand 52 in a way that allows a user to flip through the samples, or the devices and samples may cycle automatically. The devices 6 and samples 44 may be capable of being removed from the stand 52 and from the surface 40.

Having described the invention in detail and by reference to the embodiments thereof, it will be apparent that modifications and variations are possible, including the addition of elements or the rearrangement or combination or one or more elements, without departing from the scope of the invention which is defined in the appended claims.

What is claimed is:

1. A device for displaying information about a product, the device comprising:
an inner surface having printed information about the product;
an outer surface that folds over the inner surface to obscure and protect the inner surface, the outer surface having printed information about the product, and further having an attachment mechanism; and
a notch used by the operator to unfold the device to reveal the inner surface and obscure the outer surface, and to fold the device to obscure at least part of the inner surface and reveal the outer surface.

2. A device according to claim 1 wherein at least one of the inner surface and the outer surface is at least partially coated with a protective mechanism.

3. A device according to claim 1 wherein the printed information includes a description of flooring.

4. A device according to claim 1 wherein the printed information includes the dimensions of a piece of flooring.

5. A device according to claim 1 wherein the printed information includes at least one photograph of flooring.

6. A device according to claim 1 wherein the printed information includes contact information for a vendor of flooring.

7. A device according to claim 1 wherein the notch is placed at the corner of the device.

8. A device according to claim 1 wherein the notch is placed in such a way as to reveal information behind it.

9. A device according to claim 1 where the attachment mechanism is adhesive strips

10. A device according to claim 1 where the device is attached to a surface by the attachment mechanism.

11. A device according to claim 1 where the device is attached to one of a plurality of rigid sheets, the rigid sheets assembling a stand for displaying one or more devices simultaneously.

12. A method for displaying information about a product, the method comprising:
showing printed information on an inner surface of a display device;
obscuring and protecting the inner surface with an outer surface that folds over the inner surface;
showing printed information on the outer surface of the display device;
attaching the display device to another surface; and
alternately obscuring and revealing the inner surface by respectively folding and unfolding the device with the use of a notch.

13. A method according to claim 12, further comprising coating at least one of the inner surface and the outer surface with a protective mechanism.

14. A method according to claim 12, further comprising including a description of flooring in the printed information.

15. A method according to claim 12, further comprising including the dimensions of a piece of flooring in the printed information.

16. A method according to claim 12, further comprising including at least one photograph of flooring in the printed information.

17. A method according to claim 12, further comprising including contact information for a vendor of flooring in the printed information.

18. A method according to claim 12, further comprising placing the notch at the corner of the device.

19. A method according to claim 12, further comprising placing the notch in such a way as to reveal information behind it.

20. A method according to claim 12, further comprising using adhesive strips to attach the device.

21. A method according to claim 12, further comprising attaching the device to a surface by the attachment mechanism.

22. A method according to claim 12, further comprising attaching the device to one of a plurality of rigid sheets, the rigid sheets assembling a stand for displaying one or more devices simultaneously.

23. A system for displaying information about a product, the system comprising:
means for showing printed information on an inner surface of a display device;
means for obscuring and protecting the inner surface with an outer surface that folds over the inner surface;
means for showing printed information on the outer surface of the display device;
means for attaching the display device to another surface; and
means for alternately obscuring and revealing the inner surface by respectively folding and unfolding the device with the use of a notch.

24. A system according to claim 23, further comprising means for protecting at least one of the inner surface and the outer surface.

25. A system according to claim 23, further comprising means for describing flooring in the printed information.

26. A system according to claim 23, further comprising means for including the dimensions of a piece of flooring in the printed information.

27. A system according to claim 23, further comprising means for including at least one photograph of flooring in the printed information.

28. A system according to claim 23, further comprising means for including contact information for a vendor of flooring in the printed information.

29. A system according to claim 23, further comprising means for placing the notch at the corner of the device.

30. A system according to claim 23, further comprising means for placing the notch in such a way as to reveal information behind it.

31. A system according to claim 23, further comprising means for attaching the device with adhesive strips.

32. A system according to claim 23, further comprising means for attaching the device to a surface.

33. A system according to claim 23, further comprising means for attaching the device to one of a plurality of rigid sheets, the rigid sheets assembling a stand for displaying one or more devices simultaneously.
